(19) United States
(12) Patent Application Publication
(10) Pub. No.: US 2009/0325466 A1
(43) Pub. Date: Dec. 31, 2009

(54) COATED ABRASIVE ARTICLES AND METHODS OF MAKING AND USING THE SAME

(75) Inventors: Don H. Kincaid, Hudson, WI (US); Ernest L. Thurber, Somerset, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/177,496

(22) Filed: Jul. 22, 2008

Related U.S. Application Data
(63) Continuation-in-part of application No. 12/164,355, filed on Jun. 30, 2008, now abandoned.

(51) Int. Cl. B24B 1/00; C08J 5/14

(52) U.S. Cl. 451/28; 51/298

(57) ABSTRACT

A coated abrasive article comprises a backing, optionally having at least one of a presize layer, a saturant, and a backsize layer thereon; and an abrasive layer adjacent and secured to the fabric backing. The abrasive layer may comprise a make layer, a size layer, and abrasive particles, or the abrasive particles may be dispersed in a binder. At least one of the make layer or presize layer comprises a reaction product of a binder precursor comprising from 45 to 75 percent by weight of resole phenolic resin, from 5 to 40 percent by weight of polyepoxide, from 1 to 20 percent by weight of polyfunctional (meth)acrylate, and an effective amount of photoinitiator to free-radically B-stage the binder precursor. Methods of making and using the coated abrasive article are also disclosed.

### CROSS-REFERENCE TO RELATED APPLICATION

This application is a continuation-in-part of U.S. application Ser. No. 12/164,355, filed Jun. 30, 2008, the disclosure of which is incorporated herein by reference in its entirety.

### TECHNICAL FIELD

The present disclosure relates generally to the abrasive arts, and more particularly to coated abrasive articles and methods of making and using them.

### BACKGROUND

In general, coated abrasive articles have an abrasive layer secured to a backing. The abrasive layer comprises abrasive particles and a binder that secures the abrasive particles to the backing.

One common type of coated abrasive article has an abrasive layer comprised of a make layer, a size layer, and abrasive particles. In making such a coated abrasive article, a make layer precursor comprising a curable make resin is applied to a major surface of the backing. Abrasive particles are then at least partially embedded into the curable make resin (e.g., via electrostatic coating), and the curable make resin is at least partially cured (i.e., crosslinked) to adhere the abrasive particles to the backing. A size layer precursor comprising a curable size resin is then applied over the at least partially cured curable make resin and abrasive particles, followed by curing of the curable size resin precursor, and optionally further curing of the curable make resin.

Another common type of coated abrasive article has an abrasive layer secured to a major surface of a backing, wherein the abrasive layer is provided by applying a slurry of binder precursor and abrasive particles onto a major surface of a backing, and then curing the binder precursor.

Some coated abrasive articles additionally have a supersize layer covering the abrasive layer. The supersize layer typically includes grinding aids and/or anti-loading materials.

Some coated abrasive articles have one or more backing treatments such as a backsize layer (i.e., a coating on the major surface of the backing opposite the major surface having the abrasive layer), a presize layer, a tie layer (i.e., a coating between the abrasive layer and the major surface to which the abrasive layer is secured), a saturant, a subsize treatment, or a combination thereof. A subsize is similar to a saturant except that it is applied to a previously treated backing.

Phenolic resins have been used for years in abrasive articles such as, for example, including high performance resin bond products (e.g., coarse grit coated abrasive articles). Phenolic resins typically exhibit strong adhesion and cohesive strength at a relatively low cost, but are prone to viscosity reduction during curing, for example, in a festoon oven curing processes that can be detrimental to the finished abrasive product. For example, if a phenolic resin is included in a make layer precursor (also known in the art as a “make coat”), this viscosity reduction during curing can result in some loss of mineral orientation resulting in reduced abrasive performance. In the case of phenolic resin fabric backing treatments, it is common for the phenolic resin coating to form openings during drying that require repeated treatment to achieve a properly sealed backing. This second step adds time and expense to the manufacturing process. In the case of conventional phenolic make layer precursors, size layer precursors, or slurries that are cured using a festoon oven process, significant pooling of phenolic resin can occur, leading to uneven product performance.

To overcome the problems of festoon oven curing, UV/thermally curable resins such as, e.g., phenolic/acrylates, phenolic/acrylamides, epoxy/acrylates, and urea-formaldehyde/acrylates have been used to gel the make layer precursor to alleviate this viscosity reduction issue, but such curable resins have not found utility in heavy duty coarse grade belt and disc products due to insufficient mechanical and thermal properties, low grinding performance, processing issues, solvent use, and the need for new capital investments for manufacturing.

### SUMMARY

In one aspect, the present disclosure relates to a binder precursor comprising:
a) from 45 to 75 percent by weight of resole phenolic resin;
b) from 5 to 40 percent by weight of polyepoxide;
c) from 1 to 20 percent by weight of polyfunctional (meth)acrylate; and
d) an effective amount of photoinitiator to free-radically B-stage the binder precursor;
wherein the percent by weight of components a) through c) is based on a total weight of components a) through c).

The binder precursor is useful, for example, in the manufacture of coated abrasive articles.

Accordingly, in one aspect, the present disclosure provides a coated abrasive article comprising:

a fabric backing, optionally having a presize layer thereon; and

an abrasive layer adjacent and secured to the fabric backing, the abrasive layer comprising a make layer, a size layer, and abrasive particles;

wherein at least one of the make layer or the presize layer comprises a reaction product of a binder precursor comprising:
a) from 45 to 75 percent by weight of resole phenolic resin;
b) from 5 to 40 percent by weight of polyepoxide;
c) from 1 to 20 percent by weight of polyfunctional (meth)acrylate; and
d) an effective amount of photoinitiator to free-radically B-stage the binder precursor;
wherein the percent by weight of components a) through c) is based on a total weight of components a) through c).

In some embodiments, the coated abrasive article further comprises a supersize layer. In some embodiments, the make layer comprises the binder precursor. In some embodiments, the presize layer comprises the binder precursor.

In another aspect, the present disclosure provides a method of abrading a workpiece comprising:

providing a coated abrasive article according to the present disclosure;

frictionally contacting the abrasive layer with surface of the workpiece; and

moving at least one of the coated abrasive article and the workpiece relative to the other to abrade at least a portion of the surface.

In another aspect, the present disclosure provides a method of making an abrasive article, the method comprising:

providing a fabric backing;

applying a make layer precursor to the fabric backing;

embedding abrasive particles in the make layer precursor;

at least partially curing the make layer precursor to provide an at least partially cured make layer precursor;

applying a size layer precursor to at least a portion of the at least partially cured make layer precursor and abrasive particles; and

at least partially curing the size layer precursor and optionally the at least partially cured make layer precursor;

wherein the make layer precursor comprises:
a) from 45 to 75 percent by weight of resole phenolic resin;
b) from 5 to 40 percent by weight of polyepoxide;
c) from 1 to 20 percent by weight of polyfunctional (meth)acrylate;
d) from 10 to 20 percent of water; and
e) an effective amount of photoinitiator to free-radically B-stage the make layer precursor;

wherein the percent by weight of components a) through c) is based on a total weight of components a) through c).

In some embodiments, the make layer precursor is water-reducible.

In another aspect, the present disclosure provides a method of making an abrasive article comprising:

providing a fabric backing;

applying a presize layer precursor to the fabric backing, wherein the presize layer precursor comprises:
a) from 45 to 75 percent by weight of resole phenolic resin;
b) from 5 to 40 percent by weight of polyepoxide;
c) from 1 to 20 percent by weight of polyfunctional (meth)acrylate;
d) from 10 to 20 percent of water; and
e) an effective amount of photoinitiator to free-radically B-stage the presize layer precursor;

wherein the percent by weight of components a) through c) is based on a total weight of components a) through c);

at least partially curing the presize layer precursor to provide a presize layer secured to the fabric backing, wherein the presize layer substantially seals the fabric backing; and

disposing an abrasive layer on the presize layer.

In some embodiments, the presize layer precursor is water-reducible. In some embodiments, the abrasive layer comprises a make layer, a size layer, and abrasive particles. In some embodiments, the abrasive layer comprises abrasive particles dispersed in a binder.

Binder resin precursors used in practice of the present disclosure combine the above-mentioned benefits of conventional phenolic thermosets and UV curable resins while mitigating the disadvantages of those binder resins. For example, curable binder precursors used in practice of the present disclosure are not prone to viscosity reduction during festoon oven curing.

As used herein:

the verb “B-stage” means to convert to an intermediate stage of curing that will not spontaneously flow due to gravity, but will yield to applied pressure; and

the term “(meth)acryl” includes acryl, methacryl, or both;

the term “polyepoxide” means a monomer, oligomer, or polymer having at least two epoxy groups;

the term “polyfunctional poly(meth)acrylate” means an (meth)acrylate monomer, oligomer, or polymer having at least two (meth)acrylate groups.

the term “water-reducible” means dilutable by addition of water without causing phase separation.

### BRIEF DESCRIPTION OF THE DRAWING

FIG. 1 is a cross-sectional side view of an exemplary coated abrasive article according to the present disclosure.

### DETAILED DESCRIPTION

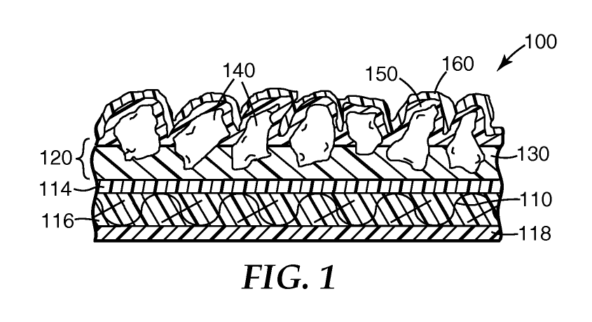

Referring now to FIG. 1, an exemplary coated abrasive article 100 comprises fabric backing 110. Fabric backing 110, optionally having at least one of a presize layer 114, a saturant 116, and a backsize layer 118 thereon. In the case that fabric backing 110 is sufficiently porous, optional backsize layer 118 and optional presize layer 114 penetrate into the backing, and may even contact each other at points within the porous interior of the backing in some cases. Overlaying optional presize layer 114 is abrasive layer 120. As shown, abrasive layer 120 comprises make layer 130 in which are embedded abrasive particles 140 and size layer 150 which overlays make layer 130 and abrasive particles 140. Optional supersize layer 160 overlays size layer 150.

At least one of presize layer 114 or make layer 130 is derived from a binder precursor comprising: a) from 45 to 75 percent by weight of resole phenolic resin; b) from 5 to 40 percent by weight of polyepoxide; c) from 1 to 20 percent by weight of polyfunctional (meth)acrylate; and d) an effective amount of photoinitiator to free-radically B-stage the binder precursor; wherein the percent by weight of components a) through c) is based on a total weight of components a) through c). Hereinafter, this binder precursor will also be referred to as Binder Precursor A.

Suitable fabric backings include, for example, those known in the art for making coated abrasive articles. Typically, the fabric backing has two opposed major surfaces. The thickness of the backing generally ranges from about 0.02 to about 5 millimeters, desirably from about 0.05 to about 2.5 millimeters, and more desirably from about 0.1 to about 0.4 millimeter, although thicknesses outside of these ranges may also be useful. Exemplary fabric backings include nonwoven fabrics (e.g., including needletacked, meltspun, spunbonded, hydroentangled, or meltblown nonwoven fabrics), knitted, stitchbonded, and woven fabrics; scrim; combinations of two or more of these materials; and treated versions thereof.

The fabric backing can be made from any known fibers, whether natural, synthetic or a blend of natural and synthetic fibers. Examples of useful fiber materials include fibers or yams comprising polyester (e.g., polyethylene terephthalate), polyamide (e.g., hexamethylene adipamide, polycaprolactam), polypropylene, acrylic (formed from a polymer of acrylonitrile), cellulose acetate, polyvinylidene chloride-vinyl chloride copolymers, vinyl chloride-acrylonitrile copolymers, graphite, polyimide, silk, cotton, linen, jute, hemp, or rayon. Useful fibers may be of virgin materials or of recycled or waste materials reclaimed from garment cuttings, carpet manufacturing, fiber manufacturing, or textile processing, for example. Useful fibers may be homogenous or a composite such as a bicomponent fiber (e.g., a co-spun sheath-core fiber). The fibers may be tensilized and crimped, but may also be continuous filaments such as those formed by an extrusion process.

The thickness of the fabric backing generally ranges from about 0.02 to about 5 millimeters, desirably from about 0.05 to about 2.5 millimeters, and more desirably from about 0. 1 to about 0.4 millimeter, although thicknesses outside of these ranges may also be useful, for example, depending on the intended use. Generally, the strength of the backing should be sufficient to resist tearing or other damage during abrading processes. The thickness and smoothness of the backing should also be suitable to provide the desired thickness and smoothness of the coated abrasive article; for example, depending on the intended application or use of the coated abrasive article.

The fabric backing may have any basis weight; typically, in a range of from 100 to 400 grams per square meter (gsm), more typically 200 to 320 gsm, and more typically 270 to 320 gsm. The fabric backing typically has good flexibility; however, this is not a requirement.

To promote adhesion of binder resins to the fabric backing, one or more surfaces of the backing may be modified by known methods including corona discharge, ultraviolet light exposure, electron beam exposure, flame discharge, and/or scuffing.

The purpose of optional backing treatments (i.e., saturant, presize layer, backsize layer) is typically to seal the backing, protect yam or fibers in the backing, and/or promote adhesion of other layer(s) (e.g., the make layer or the optional attachment interface) to the backing. Typically, at least one of these backing treatments is used, although this is not a requirement. The inclusion of a presize layer or backsize layer may additionally result in a “smoother” surface on either the front and/or the backside of the backing.

Materials useful as backing treatments include, for example, phenolics resins (especially, resole resins), epoxy resins, acrylate resins, acrylic latexes, urethane resins, aminoplasts, glue, starch, and combinations thereof. Additional materials useful as backing treatments include, for example, those described in U.S. Pat. Appl. Publ. Nos. 2005/0100739 A1 (Thurber et al); 2004/0002951 A1 (Kincaid et al.); and 2005/0282029 A1, (Keipert et al.); and U.S. Pat. No. 5,108,463 (Buchanan et al.); U.S. Pat. No. 5,137,542 (Buchanan et al.); U.S. Pat. No. 5,328,716 (Buchanan); U.S. Pat. No. 5,560,753 (Buchanan et al.); U.S. Pat. No. 6,372,336 B1 (Clausen et al.); U.S. Pat. No. 6,936,083 B2 (Thurber et al.); U.S. Pat. No. 7,344,574 B2 (Thurber et al.); and U.S. Pat. No. 7,344,575 B2 (Thurber et al.).

Backing treatments may contain additional additives such as, for example, a filler and/or an antistatic material (e.g., carbon black particles, vanadium pentoxide particles). The addition of an antistatic material can reduce the tendency of the coated abrasive article to accumulate static electricity when sanding wood or wood-like materials.

Throughout the following discussion, the terms “binder precursor” and “binder” apply to binder precursors according to the present disclosure that may be used in presize layer precursors and/or make layer precursors.

Additional exemplary backing treatments according to the present disclosure include a presize layer that comprises the reaction product of a binder precursor. The amount of resole phenolic resin included in Binder Precursor A is from 45 to 75 percent by weight, typically 45 to 65 percent by weight, and more typically 55 to 65 percent by weight, based on the total weight of components a) through c). One or a combination of resole phenolic resins may be used as the resole phenolic resin included in Binder Precursor A.

Phenolic resins are generally formed by condensation of phenol and formaldehyde, and are usually categorized as resole or novolac phenolic resins. Novolac phenolic resins are acid-catalyzed and have a molar ratio of formaldehyde to phenol of less than 1:1. Resole phenolic resins are base-catalyzed and have a molar ratio of formaldehyde to phenol of greater than or equal to 1:1; typically within a range of about 1:1 to about 3:1. One or more resole phenolic resins may be used as the resole phenolic resin included in Binder Precursor A. Resole phenolic resins can be catalyzed by alkaline catalysts, and the molar ratio of formaldehyde to phenol is greater than or equal to one, typically between 1.0 to 3.0, thus presenting pendant methylol groups. Alkaline catalysts suitable for catalyzing the reaction between aldehyde and phenolic components of resole phenolic resins include sodium hydroxide, barium hydroxide, potassium hydroxide, calcium hydroxide, organic amines, and sodium carbonate, all as solutions of the catalyst dissolved in water. A general discussion of phenolic resins and their manufacture is given in Kirk-Othmer, Encyclopedia of Chemical Technology, 4^{th} Ed., John Wiley & Sons, 1996, NY, Vol. 18, pp. 603-644.

Commercial suppliers of resole resins include, for example, Hexion Specialty Chemical, Columbus, Ohio; Durez Corp., Novi, Mich.; and Georgia-Pacific, Atlanta, Ga.

The amount of polyepoxide included in binder precursor of the presize layer precursor is from 5 to 40 percent by weight, typically 20 to 35 percent by weight, and more typically 25 to 35 percent by weight, based on the total weight of components a) through c). One or a combination of polyepoxides may be used as the polyepoxide included in binder precursor.

Polyepoxides include aliphatic epoxides, alicyclic polyepoxides, and aromatic polyepoxides.

Aliphatic polyepoxides include, for example, polyglycidyl ethers of polyhydric aliphatic alcohols, polyglycidyl esters of polyvalent fatty acids, and glycidyl aliphatic amines. Examples of polyglycidyl ethers of polyhydric aliphatic alcohols include ethylene glycol diglycidyl ether, propylene glycol diglycidyl ether, tetramethylene glycol diglycidyl ether, 1,6-hexanediol diglycidyl ether, polyethylene glycol diglycidyl ether, polypropylene glycol diglycidyl ether, polytetramethylene glycol diglycidyl ether, neopentyl glycol diglycidyl ether, trimethylolpropane triglycidyl ether, glycerol triglycidyl ether, pentaerythritol polyglycidyl ether, sorbitol polyglycidyl ether, and polyglycerol polyglycidyl ether. Examples of the polyglycidyl esters of polyvalent fatty acids include diglycidyl oxalate, diglycidyl maleate, diglycidyl succinate, diglycidyl glutarate, diglycidyl adipate, and diglycidyl pimelate.

Alicyclic polyepoxides include monomeric alicyclic polyepoxides, oligomeric alicyclic polyepoxides, polymeric alicyclic polyepoxides, and mixtures thereof. A wide variety of alicyclic polyepoxide monomers, polyepoxide oligomers, and polyepoxide polymers that are commercially available may be used in practice of the present disclosure. Exemplary alicyclic polyepoxides monomers useful in practice of the present disclosure include epoxycyclohexanecarboxylates (e.g., 3,4-epoxycyclohexylmethyl 3,4-epoxycyclohexanecarboxylate (available, for example, under the trade designation UVR-6110 from Dow Chemical Co., Midland, Mich.), 3,4-epoxy-2-methylcyclohexylmethyl 3,4-epoxy-2-methylcyclohexanecarboxylate, bis(3,4-epoxy-6-methylcyclohexylmethyl) adipate, 3,4-epoxy-6-methylcyclohexylmethyl 3,4-epoxy-6-methylcyclohexanecarboxylate (available, for example, under the trade designation ERL-4201 from Dow Chemical Co.)); vinylcyclohexene dioxide (available, for example, under the trade designation ERL-4206 from Dow Chemical Co.); bis(2,3-epoxycyclopentyl) ether (available, for example, under the trade designation ERL-0400 from Dow Chemical Co.), bis(3,4-epoxy-6-methylcyclohexylmethyl) adipate (available, for example, under the trade designation ERL-4289 from Dow Chemical Co.), dipenteric dioxide (available, for example, under the trade designation ERL-4269 from Dow Chemical Co.), 2-(3,4-epoxycyclohexyl-5,1′-spiro-3′,4′-epoxycyclohexane-1,3-dioxane, and 2,2-bis(3,4-epoxycyclohexyl)propane.

Aromatic polyepoxides include monomeric aromatic polyepoxides, oligomeric aromatic polyepoxides, polymeric aromatic polyepoxides, and mixtures thereof. Exemplary aromatic polyepoxides that can be used in the present disclosure include the polyglycidyl ethers of polyhydric phenols such as: Bisphenol A-type resins and their derivatives, including such epoxy resins having the trade designation EPON (e.g., EPON 828 and EPON 1001F), available, for example, from Resolution Performance Products, Houston, Tex.; epoxy cresol-novolac resins; Bisphenol-F resins and their derivatives; epoxy phenol-novolac resins; and glycidyl esters of aromatic carboxylic acids (e.g., phthalic acid diglycidyl ester, isophthalic acid diglycidyl ester, trimellitic acid triglycidyl ester, and pyromellitic acid tetraglycidyl ester), and mixtures thereof. Exemplary commercially available aromatic polyepoxides include those having the trade designation ARALDITE (e.g., ARALDITE MY-720, ARALDITE 721, ARALDITE 722, ARALDITE 0510, ARALDITE 0500, ARALDITE PY-306, and ARALDITE 307), available, for example, from Ciba Specialty Chemicals, Tarrytown, N.Y.; aromatic polyepoxides having the trade designation EPON (e.g., EPON DPL-862 and EPON HPT-1079), available, for example, from Hexion Specialty Chemical, Houston, Tex.; and aromatic polyepoxides having the trade designations DER, DEN (e.g., DEN 438, and DEN 439), and QUATREX, available, for example, from Dow Chemical Co.

The amount of polyfunctional (meth)acrylate included in Binder Precursor A is from 1 to 20 percent by weight, typically 5 to 15 percent by weight, and more typically 8 to 12 percent by weight, based on the total weight of components a) through c). One or a combination of polyfunctional (meth)acrylates may be used as the polyfunctional (meth)acrylate included in Binder Precursor A.

A wide variety of (meth)acrylate monomers, (meth)acrylate oligomers, and (meth)acrylated polymers are readily commercially available, for example, from such vendors as Sartomer Company, Exton, Pa., and Cytec, Stamford, Conn. Exemplary polyfunctional (meth)acrylate monomers include ethylene glycol di(meth)acrylate, hexanediol di(meth)acrylate, triethylene glycol di(meth)acrylate, trimethylolpropane tri(meth)acrylate, glycerol tri(meth)acrylate, pentaerythritol tri(meth)acrylate, ethoxylated trimethylolpropane tri(meth)acrylate, neopentyl glycol di(meth)acrylate, pentaerythritol tetra(meth)acrylate, dipentaerythritol penta(meth)acrylate, sorbitol tri(meth)acrylate, sorbitol hexa(meth)acrylate, Bisphenol A di(meth)acrylate, ethoxylated Bisphenol A di(meth)acrylates, and mixtures thereof.

Exemplary useful polyfunctional (meth)acrylate oligomers include acrylated epoxy oligomers (e.g., Bisphenol A-based epoxy acrylate oligomers such as, for example, those marketed under the trade designations EBECRYL 3500, EBECRYL 3600, EBECRYL 3720, and EBECRYL 3700 by Cytec), aliphatic urethane acrylate oligomers (e.g., as marketed by UCB Radcure under the trade designation EBECRYL 8402), aromatic urethane acrylate oligomers, and acrylated polyesters (e.g., as marketed by Cytec under the trade designation EBECRYL 870). Additional useful polyfunctional (meth)acrylate oligomers include polyether oligomers such as a polyethylene glycol 200 diacrylate, for example, as marketed by Sartomer Company under the trade designation SR 259; and polyethylene glycol 400 diacrylate, for example, as marketed by Sartomer Company under the trade designation SR 344.

Binder Precursor A comprises an effective amount of photoinitiator for free-radically B-staging Binder Precursor A (i.e., free-radically polymerizing the polyfunctional (meth)acrylate to the B-stage). For example, the curable composition may comprise from 0.1, 1, or 3 percent by weight, up to 5, 7, or even 10 percent or more by weight of photoinitiator, based on the total weight of components a) through c), although other amounts may also be used. By B-staging the binder precursor, flow of the binder precursor during heat curing (e.g., as in a festoon oven) is reduced or eliminated. One or a combination of free-radical photoinitiators may be used as the polyfunctional (meth)acrylate included in Binder Precursor A.

Exemplary photoinitiators for initiating free-radical polymerization of (meth)acrylates include benzoin and its derivatives such as alpha-methylbenzoin; alpha-phenylbenzoin; alpha-allylbenzoin; alpha-benzylbenzoin; benzoin ethers such as benzil dimethyl ketal (available, for example, under the trade designation IRGACURE 651 from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (available, for example, under the trade designation DAROCUR 1173 from Ciba Specialty Chemicals) and 1-hydroxycyclohexyl phenyl ketone (available, for example, under the trade designation IRGACURE 184 from Ciba Specialty Chemicals); 2-methyl-1-[4-(methylthio)phenyl]-2-(4-morpholinyl)-1-propanone (available, for example, under the trade designation IRGACURE 907 from Ciba Specialty Chemicals); 2-benzyl-2-(dimethlamino)-1-[4-(4-morpholinyl)phenyl]-1-butanone (available, for example, as IRGACURE 369 from Ciba Specialty Chemicals). Other useful photoinitiators include pivaloin ethyl ether, anisoin ethyl ether; anthraquinones, such as anthraquinone, 2-ethylanthraquinone, 1-chloroanthraquinone, 1,4-dimethylanthraquinone, 1-methoxyanthraquinone, benzanthraquinonehalomethyltriazines; benzophenone and its derivatives; iodonium salts and sulfonium salts as described hereinabove; titanium complexes such as bis(eta₅-2,4-cyclopentadien-1-yl)bis[2,6-difluoro-3-(1H-pyrrol-1-yl)phenyl]titanium (obtained under the trade designation CGI 784 DC, also from Ciba Specialty Chemicals); halomethylnitrobenzenes such as, for example, 4-bromomethylnitrobenzene; mono- and bis-acylphosphines (available, for example, from Ciba Specialty Chemicals as IRGACURE 1700, IRGACURE 1800, IRGACURE 1850, and DAROCUR 4265).

Binder Precursor A may comprise an optional bireactive polymerizable component, for example, a compound having at least one free-radically polymerizable group, and at least one epoxy group. Bireactive compounds can be made, for example, by introducing at least one ethylenically unsaturated group into a compound that already contains one or more epoxy groups, or, conversely, by introducing at least one epoxy group into a compound that already contains one or more ethylenically unsaturated group.

Binder Precursor A may contain a variety of additives such as, for example, fillers, thickeners, tougheners, grinding aids, pigments, fibers, tackifiers, lubricants, wetting agents, surfactants, antifoaming agents, dyes, coupling agents, plasticizers, and suspending agents.

Binder Precursor A is capable of being B-staged by actinic radiation. This has significant advantage, because once B-staged binder precursor will substantially not flow during subsequent thermal curing. In the case of backing treatments, substantial elimination of flow permits single pass coating and curing while achieving a sealed backing, while current industry processes using phenolic resins typically require two or more coating passes to achieve a properly sealed backing. In the case of make layer precursors, B-staging serves to eliminate resin pooling and retain mineral orientation, typically degraded in the case of phenolic resins during thermal curing using festoon ovens where the force of gravity can cause resin flow. In the case of size layer precursors, B-staging likewise serves to eliminate resin pooling during thermal curing using festoon ovens.

The choice of the source of actinic radiation is typically selected depending on the intended processing conditions, and to appropriately activate the photoinitiator. Exemplary useful sources of ultraviolet and visible radiation include mercury, xenon, carbon arc, tungsten filament lamps, and sunlight. Ultraviolet radiation, especially from a medium pressure mercury arc lamp or a microwave driven H-type, D-type, or V-type mercury lamp, such as of those commercially available from Fusion UV Systems, Gaithersburg, Md., is especially desirable. Exposure times for the actinic radiation typically range, for example, from less than about 0.01 second to 1 minute or longer providing, for example, a total energy exposure from 0.1 to 10 Joules per square centimeter (J/cm²) depending upon the amount and the type of reactive components involved, the energy source, web speed, the distance from the energy source, and the thickness of the make layer to be cured. Filters and/or dichroic reflectors may also be useful, for example, to reduce thermal energy that accompanies the actinic radiation.

Water may be included in Binder Precursor A, typically in an amount of at least 10 percent by weight, typically 10 to 20 percent by weight based on the total weight of components a) through c), although more or less water can be used. The role of water is primarily that of viscosity control. In this regard, it should be noted that Binder Precursor A is typically water-reducible; that is, addition of sufficient water to achieve a coatable viscosity and that does not cause substantial phase separation (e.g., as evidenced by development of a cloudy appearance) of the components in Binder Precursor A. Advantageously, this permits Binder Precursor A to be handled and coated without added volatile organic solvent.

Binder Precursor A may be further cured by exposure to thermal energy. Useful forms of thermal energy include, for example, heat and infrared radiation. Exemplary sources of thermal energy include ovens (e.g., festoon ovens), heated rolls, hot air blowers, infrared lamps, and combinations thereof.

The make layer can be formed by coating a curable make layer precursor onto a major surface of the backing. The make layer precursor may comprise, for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant alpha,beta-unsaturated groups, acrylated urethane, acrylated epoxy, acrylated isocyanurate), epoxy resin (including bis-maleimide and fluorene-modified epoxy resins), isocyanurate resin, and mixtures thereof. The make layer precursor may also comprise Binder Precursor A. The make layer precursor may be applied by any known coating method for applying a make layer to a backing, including roll coating, extrusion die coating, curtain coating, knife coating, gravure coating, spray coating, and the like.

The basis weight of the make layer utilized may depend, for example, on the intended use(s), type(s) of abrasive particles, and nature of the coated abrasive article being prepared, but generally will be in the range of from 1, 2, 5, 10, or 15 gsm to 20, 25, 100, 200, 300, 400, or even 600 gsm. The make layer may be applied by any known coating method for applying a make layer (e.g., a make coat) to a backing, including, for example, roll coating, extrusion die coating, curtain coating, knife coating, gravure coating, and spray coating.

Once the make layer precursor is coated on the backing, abrasive particles are applied to and embedded in the make layer precursor (e.g., by drop coating and/or electrostatic coating). The abrasive particles can be applied or placed randomly or in a precise pattern onto the make layer precursor.

Exemplary useful abrasive particles include fused aluminum oxide based materials such as aluminum oxide, ceramic aluminum oxide (which may include one or more metal oxide modifiers and/or seeding or nucleating agents), and heat-treated aluminum oxide, silicon carbide, co-fused alumina-zirconia, diamond, ceria, titanium diboride, cubic boron nitride, boron carbide, garnet, flint, emery, sol-gel derived abrasive particles, and blends thereof. Examples of sol-gel abrasive particles include those described in U.S. Pat. No. 4,314,827 (Leitheiser et al.); U.S. Pat. No. 4,518,397 (Leitheiser et al.); U.S. Pat. No. 4,623,364 (Cottringer et al.); U.S. Pat. No. 4,744,802 (Schwabel); U.S. Pat. No. 4,770,671 (Monroe et al.); U.S. Pat. No. 4,881,951 (Wood et al.); U.S. Pat. No. 5,011,508 (Wald et al.); U.S. Pat. No. 5,090,968 (Pellow); U.S. Pat. No. 5,139,978 (Wood); U.S. Pat. No. 5,201,916 (Berg et al.); U.S. Pat. No. 5,227,104 (Bauer); U.S. Pat. No. 5,366,523 (Rowenhorst et al.); U.S. Pat. No. 5,429,647 (Larmie); U.S. Pat. No. 5,498,269 (Larmie); and U.S. Pat. No. 5,551,963 (Larmie). The abrasive particles may be in the form of, for example, individual particles, agglomerates, abrasive composite particles, and mixtures thereof.

Exemplary agglomerates are described, for example, in U.S. Pat. No. 4,652,275 (Bloecher et al.) and U.S. Pat. No. 4,799,939 (Bloecher et al.). It is also within the scope of the present disclosure to use diluent erodible agglomerate grains as described, for example, in U.S. Pat. No. 5,078,753 (Broberg et al.). Abrasive composite particles comprise abrasive grains in a binder.

Exemplary abrasive composite particles are described, for example, in U.S. Pat. No. 5,549,962 (Holmes et al.).

Coating weights for the abrasive particles may depend, for example, on the specific coated abrasive article desired, the process for applying the abrasive particles, and the size of the abrasive particles, but typically range from 1 to 2000 gsm.

The abrasive particles typically have a size in a range of from 0.1 to about 5000 micrometers, more typically from about 1 to about 2000 micrometers; more typically from about 5 to about 1500 micrometers, more typically from about 100 to about 1500 micrometers, although other sizes may be used.

The abrasive particles are typically selected to correspond to abrasives industry accepted nominal grades such as, for example, the American National Standards Institute, Inc. (ANSI) standards, Federation of European Producers of Abrasive Products (FEPA) standards, and Japanese Industrial Standard (JIS) standards. Exemplary ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. Exemplary FEPA grade designations include: P8, P12, P16, P24, P36, P40, P50, P60, P80, P100, P120, P180, P220, P320, P400, P500, 600, P800, P1000, and P1200. Exemplary JIS grade designations include: JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS400, JIS600, JIS800, JIS1000, JIS1500, JIS2500, JIS4000, JIS6000, JIS8000, and JIS10,000.

Once the abrasive particles have been embedded in the make layer precursor, it is at least partially cured in order to preserve orientation of the mineral during application of the size layer precursor. Typically, this involves B-staging the make layer precursor, but more advanced cures may also be used if desired. B-staging may be accomplished, for example, using heat and/or light and/or use of a curative, depending on the nature of the make layer precursor selected.

Next, the size layer precursor is applied over the at least partially cured make layer precursor and abrasive particles.

The size layer can be formed by coating a curable size layer precursor onto a major surface of the backing. The size layer precursor may comprise, for example, glue, phenolic resin, aminoplast resin, urea-formaldehyde resin, melamine-formaldehyde resin, urethane resin, free-radically polymerizable polyfunctional (meth)acrylate (e.g., aminoplast resin having pendant alpha,beta-unsaturated groups, acrylated urethane, acrylated epoxy, acrylated isocyanurate), epoxy resin (including bis-maleimide and fluorene-modified epoxy resins), isocyanurate resin, and mixtures thereof. The size layer precursor may be applied by any known coating method for applying a size layer to a backing, including roll coating, extrusion die coating, curtain coating, knife coating, gravure coating, spray coating, and the like. If desired, a presize layer precursor or make layer precursor according to the present disclosure may be also used as the size layer precursor.

The basis weight of the size layer will also necessarily vary depending on the intended use(s), type(s) of abrasive particles, and nature of the coated abrasive article being prepared, but generally will be in the range of from 1 or 5 gsm to 300, 400, or even 500 gsm, or more. The size layer precursor may be applied by any known coating method for applying a size layer precursor (e.g., a size coat) to a backing including, for example, roll coating, extrusion die coating, curtain coating, and spray coating.

Once applied the size layer precursor, and typically the partially cured make layer precursor, are sufficiently cured to provide a usable coated abrasive article. In general, this curing step involves thermal energy, but this is not a requirement. Useful forms of thermal energy include, for example, heat and infrared radiation. Exemplary sources of thermal energy include ovens (e.g., festoon ovens), heated rolls, hot air blowers, infrared lamps, and combinations thereof.

In addition to other components, binder precursors, if present, in the make layer precursor and/or presize layer precursor of coated abrasive articles according to the present invention may optionally contain catalysts (e.g., thermally activated catalysts or photocatalysts), free-radical initiators (e.g., thermal initiators or photoinitiators), curing agents to facilitate cure. Such catalysts (e.g., thermally activated catalysts or photocatalysts), free-radical initiators (e.g., thermal initiators or photoinitiators), and/or curing agents may be of any type known for use in coated abrasive articles including, for example, those described herein.

In addition to other components, the make and size layer precursors may contain optional additives, for example, to modify performance and/or appearance. Exemplary additives include grinding aids, fillers, plasticizers, wetting agents, surfactants, pigments, coupling agents, fibers, lubricants, thixotropic materials, antistatic agents, suspending agents, and/or dyes.

Exemplary grinding aids, which may be organic or inorganic, include waxes, halogenated organic compounds such as chlorinated waxes like tetrachloronaphthalene, pentachloronaphthalene, and polyvinyl chloride; halide salts such as sodium chloride, potassium cryolite, sodium cryolite, ammonium cryolite, potassium tetrafluoroborate, sodium tetrafluoroborate, silicon fluorides, potassium chloride, magnesium chloride; and metals and their alloys such as tin, lead, bismuth, cobalt, antimony, cadmium, iron, and titanium; and the like. Examples of other grinding aids include sulfur, organic sulfur compounds, graphite, and metallic sulfides. A combination of different grinding aids can be used.

Exemplary antistatic agents include electrically conductive material such as vanadium pentoxide (e.g., dispersed in a sulfonated polyester), humectants, carbon black and/or graphite in a binder.

Examples of useful fillers for this invention include silica such as quartz, glass beads, glass bubbles and glass fibers; silicates such as talc, clays, (montmorillonite) feldspar, mica, calcium silicate, calcium metasilicate, sodium aluminosilicate, sodium silicate; metal sulfates such as calcium sulfate, barium sulfate, sodium sulfate, aluminum sodium sulfate, aluminum sulfate; gypsum; vermiculite; wood flour; aluminum trihydrate; carbon black; aluminum oxide; titanium dioxide; cryolite; chiolite; and metal sulfites such as calcium sulfite.

Optionally a supersize layer may be applied to at least a portion of the size layer. If present, the supersize typically includes grinding aids and/or anti-loading materials. The optional supersize layer may serve to prevent or reduce the accumulation of swarf (the material abraded from a workpiece) between abrasive particles, which can dramatically reduce the cutting ability of the coated abrasive article. Useful supersize layers typically include a grinding aid (e.g., potassium tetrafluoroborate), metal salts of fatty acids (e.g., zinc stearate or calcium stearate), salts of phosphate esters (e.g., potassium behenyl phosphate), phosphate esters, urea-formaldehyde resins, mineral oils, crosslinked silanes, crosslinked silicones, and/or fluorochemicals. Useful supersize materials are further described, for example, in U.S. Pat. No. 5,556,437 (Lee et al.). Typically, the amount of grinding aid incorporated into coated abrasive products is about 50 to about 400 gsm, more typically about 80 to about 300 gsm. The supersize may contain a binder such as for example, those used to prepare the size or make layer, but it need not have any binder.

Further details concerning coated abrasive articles comprising an abrasive layer secured to a fabric backing, wherein the abrasive layer comprises abrasive particles and make, size, and optional supersize layers are well known, and may be found, for example, in U.S. Pat. No. 4,734,104 (Broberg); U.S. Pat. No. 4,737,163 (Larkey); U.S. Pat. No. 5,203,884 (Buchanan et al.); U.S. Pat. No. 5,152,917 (Pieper et al.); U.S. Pat. No. 5,378,251 (Culler et al.); U.S. Pat. No. 5,417,726 (Stout et al.); U.S. Pat. No. 5,436,063 (Follett et al.); U.S. Pat. No. 5,496,386 (Broberg et al.); U.S. Pat. No. 5,609,706 (Benedict et al.); U.S. Pat. No. 5,520,711 (Helmin); U.S. Pat. No. 5,954,844 (Law et al.); U.S. Pat. No. 5,961,674 (Gagliardi et al.); U.S. Pat. No. 4,751,138 (Bange et al.); U.S. Pat. No. 5,766,277 (DeVoe et al.); U.S. Pat. No. 6,077,601 (DeVoe et al.); U.S. Pat. No. 6,228,133 (Thurber et al.); and No. U.S. Pat. No. 5,975,988 (Christianson).

If Binder Precursor A comprises solid components, such compositions may be prepared, for example, by mixing some or all of the various materials of the curable composition in a suitable vessel at an elevated temperature, for example, less than 100° C., sufficient to liquify at least some of the materials so that they may be efficiently mixed, with stirring, to form the curable composition, but without thermally degrading the components.

In some instances, it may be desirable to secure an optional attachment interface onto the optional backsize layer or side of the coated abrasive article opposite the abrasive layer such that the resulting coated abrasive article can be secured to a back up pad.

The abrasive attachment interface of the abrasive article mounting assembly of the present disclosure can consist of a non-continuous layer of adhesive, a sheet material, or a combination thereof. The sheet material can comprise, for example, a loop portion or a hook portion of a two-part mechanical engagement system. In other embodiment, the abrasive attachment interface comprises a layer of pressure sensitive adhesive with an optional release liner to protect it during handling.

In some embodiments, the abrasive attachment interface of the abrasive article mounting assembly of the present disclosure comprises a nonwoven, woven or knitted loop material. Suitable materials for a loop abrasive attachment interface include both woven and nonwoven materials. Woven and knit abrasive attachment interface materials can have loop-forming filaments or yams included in their fabric structure to form upstanding loops for engaging hooks. Nonwoven loop attachment interface materials can have loops formed by the interlocking fibers. In some nonwoven loop attachment interface materials, the loops are formed by stitching a yarn through the nonwoven web to form upstanding loops.

Useful nonwovens suitable for use as a loop abrasive attachment interface include, but are not limited to, airlaids, spunbonds, spunlaces, bonded melt blown webs, and bonded carded webs. The nonwoven materials can be bonded in a variety of ways known to those skilled in the art, including, for example, needle-punched, stitchbonded, hydroentangled, chemical bond, and thermal bond. The woven or nonwoven materials used can be made from natural (e.g., wood or cotton fibers), synthetic fibers (e.g., polyester or polypropylene fibers) or combinations of natural and synthetic fibers. In some embodiments, the abrasive attachment interface is made from nylon, polyester or polypropylene.

In some embodiments, a loop abrasive attachment interface having an open structure that does not significantly interfere with the flow of particles through it is selected. In some embodiments, the abrasive attachment interface material is selected, at least in part, based on the porosity of the material.

In some embodiments, the abrasive attachment interface of the abrasive article mounting assembly of the present disclosure comprises a hook material. The material used to form the hook material useful in the present disclosure may be made in one of many different ways known to those skilled in the art. Several suitable processes for making hook material useful in making abrasive attachment interfaces useful for the present disclosure, include, for example, methods described in U.S. Pat. No. 5,058,247 (Thomas et al.); U.S. Pat. No. 4,894,060 (Nestegard); U.S. Pat. No. 5,679,302 (Miller et al.), and U.S. Pat. No. 6,579,161 (Chesley et al.). The hook material may be a porous material, such as, for example the polymer netting material reported in U.S. Pat. Appln. Publ. No. 2004/0170801 (Seth et al.).

Coated abrasive articles according to the present disclosure can be converted, for example, into belts, tapes, rolls, discs (including perforated discs), and/or sheets. For belt applications, two free ends of the abrasive sheet may be joined together using known methods to form a spliced belt. A spliceless belt may also be formed as described, for example, in U.S. Pat. No. 5,573,619 (Benedict et al.).

Coated abrasive articles according to the present disclosure are useful for abrading a workpiece. One such method includes frictionally contacting at least a portion of the abrasive layer of a coated abrasive article with at least a portion of a surface of the workpiece, and moving at least one of the coated abrasive article or the workpiece relative to the other to abrade at least a portion of the surface. Examples of workpiece materials include metal, metal alloys, exotic metal alloys, ceramics, glass, wood, wood-like materials, composites, painted surfaces, plastics, reinforced plastics, stone, and/or combinations thereof. The workpiece may be flat or have a shape or contour associated with it. Exemplary workpieces include metal components, plastic components, particleboard, camshafts, crankshafts, furniture, and turbine blades.

Coated abrasive articles according to the present disclosure may be used by hand and/or used in combination with a machine. At least one or both of the coated abrasive article and the workpiece is generally moved relative to the other when abrading. Abrading may be conducted under wet or dry conditions. Exemplary liquids for wet abrading include water, water containing conventional rust inhibiting compounds, lubricant, oil, soap, and cutting fluid. The liquid may also contain defoamers, degreasers, and/or the like.

All references and patents disclosed herein are incorporated by reference in their entirety as if each were individually incorporated. Objects and advantages of this disclosure are further illustrated by the following non-limiting examples, but the particular materials and amounts thereof recited in these examples, as well as other conditions and, details, should not be construed to unduly limit this disclosure.

### EXAMPLES

Unless otherwise noted, all parts, percentages, ratios, etc. in the Examples and the rest of the specification are by weight.

MATERIALS

| ABBREVIATION | DESCRIPTION |
|---|---|
| ER1 | Epoxy resin, trimethylolpropane triglycidyl ether, obtained from |
| | Hexion Specialty Chemicals, Houston, TX, as HELOXY 48 |
| PFA | Polyfunctional acrylate, trimethylol propane triacrylate, obtained |
| | from UCB Radcure Chemical Corp., Smyrna, GA, as TMPTA-N |
| PI | Photoinitiator, 2,2-dimethoxy-2-phenylacetophenone, obtained from |
| | Ciba Specialty Chemicals, Hawthorne, NY, as IRGACURE 651. |
| PR1 | Resole phenol-formaldehyde resin, a 1.5:1 to |
| | 2.1:1 (phenol:formaldehyde) condensate catalyzed by 1 to 5% |
| | potassium hydroxide |
| PR2 | a 75 percent by weight solution of PR1 in water |
| ER2 | Epoxy resin, bisphenol A epoxy functional material, obtained from |
| | Hexion Specialty Chemicals, Houston, TX, as EPON 828 |
| ER3 | Cycloaliphatic epoxy resin, obtained from Dow Chemical Co., |
| | Midland, MI, as CYRACURE UVR 6110 |
| ER4 | Epoxy resin, obtained from Hexion Specialty Chemicals as EPI-REZ |
| | WD-510 |
| CACO1 | Calcium carbonate, obtained from Huber Engineered Materials, |
| | Quincy, IL, as HUBERCARB W4 |
| CACO2 | Calcium carbonate, obtained from Huber Engineered Materials, |
| | Quincy, IL, as HUBERCARB Q325 |
| PIGMENT | Red iron oxide pigment, obtained from Harcos Pigments Inc., |
| | Valparaiso, IN, as KROMA |
| CRY | Cryolite, obtained from TR International Trading Company, Inc., |
| | Houston, TX, as RTNC CRYOLITE |
| DICY | Dicyandiamide, obtained from Air Products and Chemicals, |
| | Allentown, PA, as Amicure CG-1400 |
| NOV1 | Novolac resin, obtained from Hexion Specialty Chemicals as |
| | RUTAPHEN 8656F |
| CUR1 | 2-propylimidazole, obtained from Synthron, Morganton, NC, as |
| | ACTIRON NXJ-60 LIQUID |

### Binder Precursor Compositions

### Preparation of Composition RC1

A 4-ounce (0.1-liter) jar was charged with 34.6 grams of ER1, 5.75 grams of PFA, and 1 gram of PI. The mixture was placed in an oven at 59-60° C. for 15 minutes. Next, the sample was mixed with an overhead stirrer and allowed to cool to room temperature over 15 minutes. Next, 79.5 grams of PR2 (59.6 g solids) was added to the mixture. The mixture was mixed with an overhead stirrer for 5 minutes. The resulting composition was clear and homogenous.

### Preparation of Compositions RC2-RC5 and RCA-RCD

Compositions RC2-RC5 and RCA-RCD were made as in the case of RC1, with the exception of compositional changes noted in Table 1 (below), which reports each composition and its appearance.

TABLE 1

| | Components (based on | | | | |
|---|---|---|---|---|---|
| | solids), grams | | | | |
| Composition | PR1 | ER1 | PFA | PI | OBSERVATIONS |
| RC1 | 59.62 | 34.62 | 5.75 | 1 | clear and homogeneous |
| RC2 | 59.62 | 25.12 | 15.25 | 1 | clear and homogeneous |
| RC3 | 83.62 | 10.62 | 5.75 | 1 | clear and homogeneous |
| RC4 | 69.24 | 20.25 | 10.50 | 1 | clear and homogeneous |
| RC5 | 74.12 | 10.62 | 15.25 | 1 | slight phase separation |
| RCA | 78.99 | 1 | 20.00 | 1 | composition phase separated |
| RCB | 50.01 | 30 | 19.99 | 1 | composition phase separate |
| RCC | 50.01 | 49 | 0.99 | 1 | clear and homogeneous, |
| | | | | | extreme mineral wicking |
| RCD | 98.00 | 1.00 | 1.00 | 1 | clear and homogeneous, |
| | | | | | wicking of mineral |

In Examples RC1-1C5 and RCA-RCD the PR1 was added as PR2, but to facilitate comparison Table 1 reports the actual amount of PR1 present in the PR2.

In Table 1, phase separation was determined by visible inspection after letting sample sit for 10 minutes after mixing. The mineral wicking was determined by coating formulation onto a microscope slide using a one-inch (2.5-cm) knife set at a gap of 10 mils (0.25 mm) gap. The coated slide was irradiated with an ultraviolet (UV) Fusion System lamp (118 watts/cm (118 j/cm-sec), D bulb, Gaithersburg, Md.), at a line speed of 5 meters per minute to react the polyfunctional (meth)acrylate, subsequently grade 36 brown aluminum oxide was drop coated onto the glass slide. The glass slide was thermally cured at 90° C. for 90 minutes and 102° C. for 10 hours. Wicking of resin around mineral was determined by placing material under a microscope.

### Presize Precursor Compositions

### Preparation of Composition RC6-RC10 and Comparative RCJ

4-ounce (0. 1-liter) jars were independently charged with the amounts ER2, PFA, and PI indicated in Table 2. The mixtures were placed in an oven at 59-60° C. for 15 minutes, then mixed with an overhead stirrer and allowed to cool to room temperature over 15 minutes. Next, PR1, in the amounts listed in Table 2, was added to the resultant mixtures with mixing with an overhead stirrer for 5 minutes.

TABLE 2

| | COMPONENT (based on solids), parts | | | | | |
|---|---|---|---|---|---|---|
| COMPOSITION | PR1 | ER2 | ER3 | PFA | ER4 | PI |
| RC6 | 65.2 | 23.2 | 0 | 11.6 | 0 | 1 |
| RC7 | 61.6 | 21.9 | 0 | 16.4 | 0 | 1 |
| RC8 | 65.2 | 0 | 23.2 | 11.6 | 0 | 1 |
| RC9 | 61.6 | 21.9 | 0 | 16.4 | 0 | 1 |
| RC10 | 48.8 | 0 | 0 | 6.0 | 35.8 | 1 |
| RCJ | 87.1 | 6.4 | 0 | 6.5 | 0 | 1 |

In Examples RC6-RC10 and RCJ the PR1 was added as PR2, but to facilitate comparison Table 2 reports the actual amount of PR1 present in the PR2.

### Composition RCK

EP2 (11306 g) was mixed with 1507 g of PFA and 151 g of PI at 20° C. until homogeneous using a mechanical stirrer. The mixture was then heated at 50° C. in an oven for 2 hours. After removing the mixture from the oven, 1206 g of DICY and 754 grams NOV1 were added and with stirring over 10 minutes. CUR1 (114 grams) was then added and stirring continued until dissolved.

### Comparative RCE

A conventional backsize composition of PR1 filled with about 60 percent CACO2 and 2 percent by weight PIGMENT was prepared and diluted to 75% solids with water.

### Make Coat Compositions

### Composition RC11

An 8-ounce (0.2-liter) jar was charged with 28.6 grams of ER1, 9.17 grams of PFA and 1.83 grams of PI. The mixture was placed in an oven at 59-60° C. for 15 minutes. Next, the sample was mixed with an overhead stirrer and allowed to cool to room temperature over 15 minutes. Next, 76.5 grams of PR2, 10.4 grams of water and 103 grams of CACO1. The mixture was mixed with an overhead stirrer for 20 minutes.

### Composition RC12

An 8-ounce (0.2-liter) jar was charged with 28.6 gram ER2, 9.17 grams of PFA and 1.83 grams PI. The mixture was placed in an oven at 59-60° C. for 15 minutes. Next, the sample was mixed with an overhead stirrer and allowed to cool to room temperature over 15 minutes. Next, 76.5 grams of PR2, 10.4 grams of water, and 103 grams of CACO1 was added to the mixture. The mixture was mixed with an overhead stirrer for 20 minutes.

### Composition RCF

A composition of PR1 filled with about 45 to 50 percent by weight of CACO1 based on the total weight of the composition was prepared and diluted to 80-85 percent solids by weight with water to provide RCF make coat composition

### Size Coat Compositions

### Composition RCG

A composition of PR1 filled with about 66% by weight CRY, based on the total weight of the composition was provided. In addition, about 2 percent by weight of PIGMENT was added, and the composition diluted to 80 to 85 percent by weight with water.

### Composition RCH

A supersize composition according to Example 26 of U.S. Pat. No. 5,441,549 (Helmin).

### Coated Abrasive Articles Containing Treated Backings

### General Preparation of Treated Backings

A 10.2 cm wide coating knife obtained from Gardco, Pompano Beach, Fla., was prepared for use. The knife was set to a minimum gap of 76 micrometers to permit 15.2 cm wide cloth backing to pass under the knife. Untreated polyester woven cloth having a weight of 300-400 grams per square meter (g/m²) was obtained from Milliken & Company, Spartanburg, S.C. The polyester cloth was placed under the coating knife set at 76 micrometers and then the presize compositions of Table 2 were applied to the polyester cloth by pulling the polyester cloth by hand under the knife to form a presize coat on the polyester cloth. The coated cloth backings were irradiated with an ultraviolet (UV) lamp (118 Watts/cm, D bulb, obtained from Fusion UV Systems, Gaithersburg, Md.), at a line speed of about 5 meters per minute to polymerize the polyfunctional (meth)acrylate and then the coated backings were thermally cured at 90° C. for 10 minutes, 110° C. for 10 minutes and 125° C. for 10 minutes. The resultant presize treated fabric backing was treated with a backsize precursor composition using the same knife coating method. The backsize precursor was cured by placing the treated cloth backing in the oven at 90° C. for 10 minutes and at 105° C. for 15 minutes. Results for various backings are reported in Table 3 (below).

TABLE 3

| | PRESIZE | BACKSIZE | |
|---|---|---|---|
| BACKING | PRECURSOR | COMPOSITION | NOTES |
| TC1 | Composition RC6 | Composition | |
| | | RCE | |
| TC2 | Composition RC7 | Composition | |
| | | RCE | |
| TC3 | Composition RC8 | Composition | |
| | | RCE | |
| TC4 | Composition RC9 | Composition | |
| | | RCE | |
| TC5, | Composition RCJ | Composition | presize precursor |
| comparative | | RCE | soaked through |
| | | | cloth during curing |
| TC6 | RC10 | Composition | |
| | | RCE | |

### Coated Abrasives

### 90-Degree Peel Adhesion Test

The abrasive articles to be tested were converted into an 8 centimeters (cm) wide by 25 cm long piece. One-half the length of a wooden board (17.8 cm by 7.6 cm×0.6 cm thick) was coated with laminated adhesive depending on construction. The entire width, but only the first 15 cm length, of the coated abrasive was coated with laminating adhesive (a polyamide hot melt adhesive available as JET MELT BRAND ADHESIVE PG3779 from 3M Industrial Specialties Division, 3M Company, St. Paul, Minn.) on the side bearing the abrasive particles. The side of the coated abrasive article bearing the abrasive particle was attached to the side of the board containing the laminate adhesive coating in such a manner that the 10 cm of the coated abrasive not bearing the laminating adhesive overhung for the board. Pressure was applied such that the board and the coated abrasive were intimately bonded. The board and coated abrasive with laminating adhesive was cooled to room temperature for at least 1 hour before testing. Next, the coated abrasive article to be tested was cut along a straight line on both sides of the article such that the width of the coated abrasive was reduced to 5.1 cm. The resulting coated abrasive article/board composite was mounted horizontally in a fixture attached to the upper jaw of the a tensile testing machine obtained under the trade designation SINTECH 6W from MTS Systems Corp., Eden Prairie, Minn., and approximately 1 cm of the overhanging portion of the coated abrasive article was mounted into the lower jaw of the machine such that the distance between the jaw was 12.7 cm. The machine separated the jaws at a rate of 0.05 cm/second, with the coated abrasive article being pulled at an angle of 90-degree away from the wooden board so that a portion of the coated abrasive article separated from the board. Separation occurred between layered of the coated abrasive article. The force required for separation from the coated abrasive article from board was charted by the machine and is expressed in pounds per inch (lb/in). The higher the required force, the better the adhesion of the make coat to the presize coat to the backing.

Preparation of Coated Abrasives from Treated Backings

The treated backings TC1-TC6 from Table 3 were independently coated with Composition RCF onto the presize layer coated side of the treated backing using the knife coating procedure in the General Preparation of Treated Backings described above. Next, grade 36 aluminum oxide mineral (commercially available under the trade designation ALODUR from Treibacher GmbH, Treibach, Germany) was drop coated to form a closed coat into the make layer precursor, then the abrasive-coated material was cured at 90° C. for 60 minutes and 105° C. for 10 hours resulting in respective coated abrasives ABR1-ABR6. 90-degree peel adhesion results are reported in Table 4 (below).

TABLE 4

| | 90-DEGREE PEEL | |
|---|---|---|
| COATED | ADHESION TEST, | |
| ABRASIVE | lb/in (kg/cm) | NOTES |
| ABR1 | 26.7 (4.78) | |
| | 26.4 (4.72) | |
| | 29.9 (5.35) | |
| ABR2 | 29.7 (5.31) | |
| | 26.6 (4.76) | |
| | 27.2 (4.87) | |
| ABR3 | 26.8 (4.80) | |
| | 30.3 (5.42) | |
| | 29.4 (5.26) | |
| ABR4 | 26.4 (4.72) | |
| | 27.0 (4.83) | |
| | 25.2 (4.51) | |
| ABR5, | 18.7 (3.35) | |
| comparative | 20.2 (3.61) | |
| | 21.6 (3.87) | |
| ABR6 | 26.8 (4.80) | |
| | 25.9 (4.63) | |
| | 27.9 (4.99) | |
| ABR7, | 34.1 (6.10) | Treated Cloth backing used was as |
| Comparative | 35.7 (6.39) | described in U.S. Pat. No. 6,843,815 |
| | 33.8 (6.05) | (Thurber et al.), Table 1, |
| | | Backing Example 12 |

### Coated Abrasive Constructions Containing Make Layer Compositions

### Grinding Test Procedure

A grinding test was conducted on 10.16 cm×91.44 cm belts. The workpiece was a 304 stainless steel bar on which the surface to be abraded measured 1.9 cm by 1.9 cm. A 20.3 cm diameter 70 durometer rubber, 1:1 land to groove ratio, serrated contact wheel was used. The belt was run at 2750 rpm. The workpiece was applied to the center part of the belt at a normal force of 5 pounds (2.2 kg). The test consisted of measuring the weight loss of the workpiece after 15 seconds of grinding. The workpiece would then be cooled and tested again. The test was concluded when cut rate (grams/15 seconds) was 50% of initial cut rate. The total cut in grams was then recorded.

### Coated Abrasive Belt 1C, Comparative

Comparative Cloth 2 was coated with 70 grains/24 in² (293 g/m²) of Composition RC12 using a 30.5 cm wide roll, subsequently about 100 grains/24 in² (418 g/m²) of grade 36 aluminum oxide was drop coated into the make layer precursor and then about 109 grains/24 in² (456 g/m²) of grade 36 abrasive (available as CUBITRON 222 from 3M Company, St. Paul, Minn.) was electrostatically coated into the make layer precursor. Next, the construction was cured at 90° C. for about 60 minutes and at 100° C. for 30 minutes. Next, about 110 grains/24 in² (460 g/m²) of Composition RCG was roll coated over the at least partially cured make layer precursor and abrasive particles, and then cured at 90° C. for 60 minutes and at 105° C. for 12 hours. A strip of the resulting coated abrasive measuring 10.16 cm wide and 91.44 cm long was converted into a coated abrasive belt using a polyester splicing film available from Sheldahl, Northfield, Minn., and evaluated according to the 90-Degree Peel Adhesion Test, see Table 5.

### Coated Abrasive Belt 1

Comparative Cloth 2 was coated with 70 grains/24 in² (293 g/m²) of Composition RC12 using a 30.5 cm wide roll, followed by irradiation of the coated composition with an ultraviolet lamp (118 Watts/cm, D bulb, obtained from Fusion UV Systems), at about 5 meters per minute to react the polyfunctional (meth)acrylate. Subsequently about 100 grains/24 in² (418 g/m²) of grade 36 aluminum oxide was drop coated into the make resin and then about 109 grains/24 in² (456 g/m²) of grade 36 CUBITRON 222 was electrostatically coated into the make resin. Next, the construction was cured at 90° C. for about 60 minutes and at 100° C. for 30 minutes. Next, about 110 grains/24 in² (460 g/m²) of comparative size coat composition RCG was roll coated over the make resin and cure at 90° C. for 60 minutes and at 105° C. for 12 hours. A strip of the resulting coated abrasive measuring 10.16 cm wide and 91.44 cm long was converted into a coated abrasive belt using a polyester splicing film as above, and evaluated according to the 90-Degree Peel Adhesion Test, see Table 5 (below).

TABLE 5

| | 90-DEGREE PEEL |
|---|---|
| | ADHESION TEST, |
| | lb/in (kg/cm) |
| Coated Abrasive Belt 1C, | 31.8 (5.69) |
| Comparative | 32.7 (5.85) |
| | 33.5 (5.99) |
| Coated Abrasive Belt 1 | 37.6 (6.73) |
| | 37.0 (6.62) |
| | 35.0 (6.26) |

### Coated Abrasive Belt 2C, Comparative

Comparative Cloth 2 was coated with 72 grains/24 in² (301 g/m²) of Composition RCF using a 30.5 cm wide roll, subsequently about 182 grains/24 in² (761 g/m²) of blend a of grade 36 brown aluminum oxide/CUBITRON 321 was electrostatically coated into the make resin. Next, the construction was cured at 90° C. for about 60 minutes and at 100° C. for 30 minutes. Next, about 77 grains/24 in² (322 g/m²) of Comparative size coat composition RCG was roll coated over the make resin and cured at 90° C. for 60 minutes and at 105° C. for 12 hours. Next, 100 grain/24 in² (418 g/m²) of Comparative supersize RCH was roll coated over the size coat and cured at 90° C. for 60 minutes and 2 hours at 120° C. A strip of the resulting coated abrasive measuring 10.16 cm wide and 91.44 cm long was converted into a coated abrasive belt using a polyester splicing film as above, and evaluated according to the Grinding Test Procedure, see Table 6 (below).

### Coated Abrasive Belt 2

Comparative Cloth 2 was coated with 72 grains/24 in² (301 g/m²) of Composition RC11 followed by irradiation of make resin with an ultraviolet lamp (118 Watts/cm, D bulb, obtained from Fusion UV Systems, Gaithersburg, Md.), at a line speed of about 5 meters per minute using a 30.5 cm wide roll. Subsequently about 182 grains/24 in² (761 g/m²) of grade 36 brown aluminum oxide/CUBITRON 321 was electrostatically coated into the make resin. Next, the construction was cured at 90° C. for about 60 minutes and at 100° C. for 30 minutes. Next, about 77 grains/24 in² (322 g/m²) of comparative size coat composition RCG was roll coated over the make resin and cure at 90° C. for 60 minutes and at 105° C. for 12 hours. Next, 100 grain/24 in² (418 g/m²) of comparative supersize RCH was rolled coated over the size coating and cured at 90 degrees C. for 60 minutes and 2 hours at 120° C. A strip of the resulting coated abrasive measuring 10.16 cm wide and 91.44 cm long was converted into a coated abrasive belt using a polyester splicing film as above, and evaluated according to the Grinding Test Procedure, see Table 6 (below).

TABLE 6

| | TOTAL CUT AT 50 PERCENT |
|---|---|
| | OF INITIAL CUT RATE, grams |
| Coated Abrasive Belt 2, | 26.89 |
| Comparative | 21.55 |
| | 28.09 |
| | 25.03 |
| Coated Abrasive Belt 2 | 35.87 |
| | 37.61 |
| | 32.54 |
| | 40.14 |

Various modifications and alterations of this disclosure may be made by those skilled in the art without departing from the scope and spirit of this disclosure, and it should be understood that this disclosure is not to be unduly limited to the illustrative embodiments set forth herein.

1. A coated abrasive article comprising:
a fabric backing, optionally having a presize layer thereon; and
an abrasive layer adjacent and secured to the fabric backing, the abrasive layer comprising a make layer, a size layer, and abrasive particles;
wherein at least one of the make layer or the presize layer comprises a reaction product of a binder precursor comprising:
a) from 45 to 75 percent by weight of resole phenolic resin;
b) from 5 to 40 percent by weight of polyepoxide;
c) from 1 to 15 percent by weight of polyfunctional (meth)acrylate; and
d) an effective amount of photoinitiator to free-radically B-stage the binder precursor;
wherein the percent by weight of components a) through c) is based on a total weight of components a) through c).

2. The coated abrasive article of claim 1, further comprising a supersize layer.

3. The coated abrasive article of claim 1 wherein the make layer comprises the binder precursor.

4. The coated abrasive article of claim 1, wherein the presize layer comprises the binder precursor.

5. A method of abrading a workpiece comprising:
providing a coated abrasive article according to claim 1;
frictionally contacting the abrasive layer with surface of the workpiece; and
moving at least one of the coated abrasive article and the workpiece relative to the other to abrade at least a portion of the surface.

6. A method of making an abrasive article, the method comprising:
providing a fabric backing;
applying a make layer precursor to the fabric backing;
embedding abrasive particles in the make layer precursor;
at least partially curing the make layer precursor to provide an at least partially cured make layer precursor;
applying a size layer precursor to at least a portion of the at least partially cured make layer precursor and abrasive particles; and
at least partially curing the size layer precursor and optionally the at least partially cured make layer precursor;
wherein the make layer precursor comprises:
a) from 45 to 75 percent by weight of resole phenolic resin;
b) from 5 to 40 percent by weight of polyepoxide;
c) from 1 to 20 percent by weight of polyfunctional (meth)acrylate;
d) from 10 to 20 percent of water; and
e) an effective amount of photoinitiator to free-radically B-stage the make layer precursor;
wherein the percent by weight of components a) through c) is based on a total weight of components a) through c).

7. The method of claim 6, wherein the make layer precursor is water-reducible.

8. A method of making an abrasive article comprising:
providing a fabric backing;
applying a presize layer precursor to the fabric backing, wherein the presize layer precursor comprises:
a) from 45 to 75 percent by weight of resole phenolic resin;
b) from 5 to 40 percent by weight of polyepoxide;
c) from 1 to 20 percent by weight of polyfunctional (meth)acrylate;
d) from 10 to 20 percent of water; and
e) an effective amount of photoinitiator to free-radically B-stage the presize layer precursor;
wherein the percent by weight of components a) through c) is based on a total weight of components a) through c);
at least partially curing the presize layer precursor to provide a presize layer secured to the fabric backing, wherein the presize layer substantially seals the fabric backing; and
disposing an abrasive layer on the presize layer.

9. The method of claim 8, wherein the presize layer precursor is water-reducible.

10. The method of claim 8, wherein the abrasive layer comprises a make layer, a size layer, and abrasive particles.

11. The method of claim 8, wherein the abrasive layer comprises abrasive particles dispersed in a binder.
